(19) United States
(12) Patent Application Publication
(10) Pub. No.: US 2016/0078692 A1
(43) Pub. Date: Mar. 17, 2016

(54) METHOD AND SYSTEM FOR SHARING TRANSPORT INFORMATION

(71) Applicant: MasterCard International Incorporated, Purchase, NY (US)

(72) Inventor: Ramson Tutte, Maynooth (IE)

(21) Appl. No.: 14/852,829

(22) Filed: Sep. 14, 2015

(30) Foreign Application Priority Data
Sep. 16, 2014 (GB) 1416318.2

(51) Int. Cl. G07C 5/08; G01C 21/26

(52) U.S. Cl. CPC G07C 5/08; G01C 21/26

(57) ABSTRACT

Provided are a computer-implemented method and system for providing transport information to a plurality of user computing devices. The method is performed by a cloud computing system and includes operating a processor associated with the cloud computing system to: analyse vehicle data collated from one or more vehicles remote from the cloud computing system to generate processed vehicle data; and configure the processed vehicle data to be accessed through a portal of each of the user computing devices.

### CROSS REFERENCE TO RELATED APPLICATIONS

This application claims foreign priority to United Kingdom Patent Application 1416318.2, filed 16 Sep. 2014, the complete disclosure of which is expressly incorporated herein by reference in its entirety for all purposes.

### FIELD OF THE INVENTION

The present disclosure relates to vehicular data. More particularly, it relates to a method and system for collating vehicular data and analysing the data to generate processed vehicle data to be shared with multiple users.

### BACKGROUND OF THE DISCLOSURE

On-board diagnostics (OBD) is an automotive term referring to self-diagnostic and reporting capability of a vehicle. OBD systems provide a vehicle owner or repair technician access to the status of the various vehicle sub-systems. Modern OBD implementations use a standardized digital communications port to provide real-time data in addition to a standardized series of diagnostic trouble codes, or DTCs, which allow one to rapidly identify and remedy malfunctions within the vehicle. Controller Area Network (CAN) bus is a vehicle bus standard designed to allow microcontrollers and devices to communicate with each other within a vehicle without a host computer. CAN bus is a message-based protocol, designed specifically for automotive applications but now also used in other areas such as aerospace, maritime, industrial automation and medical equipment.

A typical on-board diagnostics (OBD) device may be configured to interface with an OBD port of a vehicle and receive power and data communications therefrom. The OBD device may comprise computer circuitry configured to receive time, location, and/or distance information associated with a journey taken by the vehicle, the information being received through the OBD port of the vehicle. The computer circuitry may be configured to communicate with a computing device disposed within the vehicle over a local area network when the OBD device is connected to the OBD port. Also, the computer circuitry may be configured to communicate the journey information received from the vehicle to a data cloud external to the vehicle.

The vehicle may further include a GPS receiver. The GPS receiver may be electrically coupled to an antenna external to the OBD device. The computer circuitry may be configured to communicate with external computing devices including the cloud over a 3G/4G, Bluetooth or Wi-Fi connection. The computer circuitry may be configured to transmit odometer information to the external computing devices. Furthermore, the one or more external computing devices may be smartphones.

A process of communicating vehicle information may include receiving odometer, time, and/or location information from an on-board diagnostics (OBD) system of a vehicle over a wired connection; communicatively linking wirelessly with a mobile computing device disposed within the vehicle; and transmitting the odometer, time, and/or location information over the wireless link while the vehicle is in transit.

An intelligent cloud-based system for detecting and monitoring vehicular traffic is also known. Such a system generally comprises a cloud server and an on-board terminal. A fleet of cloud servers may be deployed. The reason for using a cloud based solution is to scale up or down depending on the demand and volume of traffic data. The on-board terminal is configured to acquire vehicle parameters and vehicle component running state parameters through one or more OBD sensors, acquire vehicle location information through a GPS module and send the information to the cloud server. The GPS module may be external to the vehicle or may be a GPS device already installed in the vehicle. The cloud server is configured to receive and analyse the vehicle parameters and location information. Data resulting from the analysis may be transmitted back to the on-board terminal. For example, a comparison may be conducted according to stored reference data of different types of vehicles. Signals may be generated if it is determined that vehicles are running abnormally, and fault guide information may be generated according to the location information of the vehicles and stored information of maps and garages. The information transmitted to the on-board terminal can be used to remind drivers when detecting abnormal vehicle conditions, and other abnormalities.

In view of the above, there are many situations where it would be desirable to share data obtained from the vehicle parameters and location information with other users. An improved system for providing transport information to a user would therefore be desirable.

### SUMMARY OF THE INVENTION

The present disclosure provides a computer-implemented method for providing transport information to a plurality of user computing devices. The method is performed by a cloud computing system and includes operating a processor associated with the cloud computing system to: analyse vehicle data collated from one or more vehicles remote from the cloud computing system to generate processed vehicle data; and configure the processed vehicle data to be accessed through a portal of each of the user computing devices.

Also provided is a cloud computing system configured to deliver processed vehicle data to a plurality of user computing devices; the cloud computing system includes: a memory; and a processor configured to perform the method described just above.

The present disclosure further provides a computing device configured to receive processed vehicle data from a cloud computing system as described just above. The computing device includes a processor and a display configured to display the processed vehicle data. The computing device is remote from the cloud computing system.

The present disclosure even further provides a computer-readable medium including non-transitory instructions which, when executed, cause a processor to carry out the method described just above.

Advantageous features are provided in the dependent claims.

### BRIEF DESCRIPTION OF THE DRAWINGS

Embodiments of the present disclosure will now be described, by way of example only, with reference to the accompanying drawings, in which:

FIG. 1 illustrates an example of a system for providing processed vehicle data to a user, according to an embodiment of the present disclosure;

FIG. 2A is a diagram depicting an example of journey statements displayed on a display device, according to an embodiment of the present disclosure;

FIG. 2B is a diagram depicting an example of trip behaviour displayed on a display device, according to an embodiment of the present disclosure;

FIG. 2C is a diagram depicting an example of trip trading options displayed on a display device, according to an embodiment of the present disclosure; and

FIG. 3 is a block diagram illustrating an exemplary configuration of a mobile device according to an embodiment of the present disclosure.

### DETAILED DESCRIPTION

Embodiments of the present disclosure will now be described with reference to an exemplary system for collating and analysing vehicular data and analysing the data to generate processed vehicle data to be shared with multiple users. It will be understood that the exemplary system is provided to assist in an understanding of the present teaching and is not to be construed as limiting in any fashion. Furthermore, modules or elements that are described with reference to any one Figure may be interchanged with those of other Figures or other equivalent elements without departing from the spirit of the present teaching.

In at least one embodiment, the present disclosure provides a computer-implemented method for providing transport information to a plurality of user computing devices, the method being performed by a cloud computing system and comprising operating a processor associated with the cloud computing system to: analyse vehicle data collated from one or more vehicles remote from the cloud computing system to generate processed vehicle data; and configure the processed vehicle data to be accessed through a portal of each of the user computing devices. The vehicle data may comprise at least one of vehicle metrics, on-board diagnostic (OBD) data and GPS data. The vehicle metrics may comprise for example, torque, engine speed, vehicle speed, odometer reading, and the like. The vehicle metrics constitute vehicle information other than data related to vehicle diagnostic data and is thus distinct from OBD data.

The step of collating vehicle data from one or more vehicles is known to those skilled in the art. Such a system generally comprises a cloud server and an on-board terminal in each of the vehicles. Such architecture is generally well known in the art. The on-board terminal in the vehicle is configured to acquire vehicle parameters and vehicle component running state parameters through one or more OBD sensors, acquire vehicle location information through a GPS module and send the vehicle data to the cloud server. The cloud server is configured to receive and analyse the vehicle parameters and location information. Data resulting from the analysis may be transmitted back as processed data to the on-board terminal. The processed data may be in the form of vehicular analysis data and/or transport information as described below.

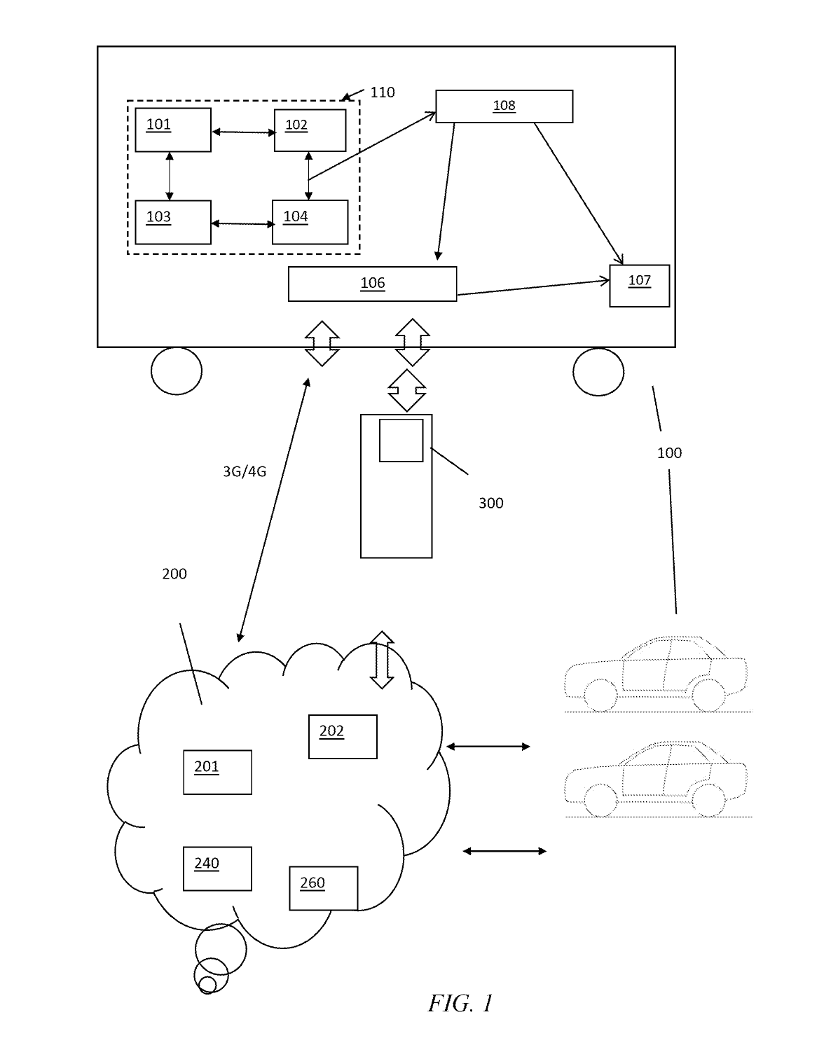

FIG. 1 illustrates an example of a system for providing processed vehicle data to a user, according to an embodiment of the present disclosure. Referring to FIG. 1, the system generally includes one or more vehicles 100, each of which is configured to transmit vehicle data received from the respective vehicle 100 to a computing device external to the vehicle 100, such as a cloud server 200. The vehicles 100 may include mobile land vehicles such as motorcycles, cars, trucks, or the like, water vehicles such as boats, or aircraft such as planes, helicopters, or the like. Each of the vehicles 100 may be configured with suitable hardware and software so as to be enabled to transmit and/or receive voice and data communications with the cloud server 200. Each of the vehicles 100 may include a Controller Area Network (CAN) bus 110 comprising a series of microcontrollers and sensors 101 to 104 to receive time, location, and/or distance information associated with a journey taken by the vehicle 100. The vehicle data may include vehicle metrics comprising at least one of trip distance, trip route, average speed, start time, arrival time, odometer reading, and fuel consumption. This information is hereinafter collectively referred to as vehicle metrics. As mentioned above, it will be understood that the vehicle metrics comprises data other than data related to vehicle diagnostic data. The vehicle data may also comprise on-board diagnostic (OBD) data and GPS data. Referring to FIG. 1, the vehicle data may be received at an OBD port 108 of the vehicle. The OBD port 108 may comprise computer circuitry including a processor configured to receive the vehicle data associated with journeys taken by the vehicle 100. The computer circuitry may be configured to communicate with a computing device disposed within the vehicle 100 over a local area network. Also, the computer circuitry may be configured to communicate the vehicle data received from the vehicle 100 to the cloud server 200 via a vehicle interface module 106. It will be understood by the skilled person that the vehicle interface module 106 is a device that plugs into the OBD port 108 and translates the signals specific to each car manufacturer into a common format for consumption. OBD data is specific to car manufacturer. For example, OBD data received from an Audi vehicle might not be compatible with that from a Ford vehicle. The computer circuitry may be configured to communicate with one or more external computing devices 300 and the cloud server 200 over a 3G or 4G network connection. The one or more external computing devices 300 may include smartphones, tablet devices, personal computers or the like.

Each of the vehicles 100 may have a portal disposed therein through which the processed vehicle data can be accessed. For example the portal may comprise a display 107. The display 107 may be operatively connected to the OBD port 108. The display 107 may include a screen or any other such presentation device that enables the user of the vehicle 100 to view various options, parameters, and results. For example, the display may be configured to display the vehicle data referred to above, and to display vehicular analysis data and/or transport information generated at the cloud server 200. The display 107 may be a digital display such as an LED display, and may include a graphical user interface. For example, the display 107 may be a touch screen display in which a graphical user interface may be integrated. Each of the one or more external computing devices 300 and the vehicles 100 may be configured to run an application which implements the methods of the present disclosure. For example, the methods may be primarily aimed at users of mobile devices such as smartphones. The methods may be embodied as part of an application or ‘app’ on a mobile device.

The cloud server 200 may be an Internet-based computing environment, and may be configured to be accessible by the vehicle 100, for example by a telematics unit, via the Internet or the world-wide-web. The cloud server 200 may be configured to receive data from the OBD port 108 of the vehicle 100 via the vehicle interface 106. The cloud server 200 may include suitable physical and/or virtual hardware operatively coupled over a network so as to perform specific computing tasks, such as tasks related to the examples of the method disclosed herein. For example, the cloud server 200 may include a processor 201, memory device(s) 202, and communication interface 240. The processor 201 may be configured to run software 260 such as an application which implements the methods according to the present disclosure. The application may include computer readable code embedded on a non-transitory, tangible computer readable medium. The application may be a type of social media application configured to run on the external computing devices 300. The application may be configured for execution by a processor of each of the vehicles 100 to display vehicular analysis data and/or transport information on the display 107 of the respective vehicle 100.

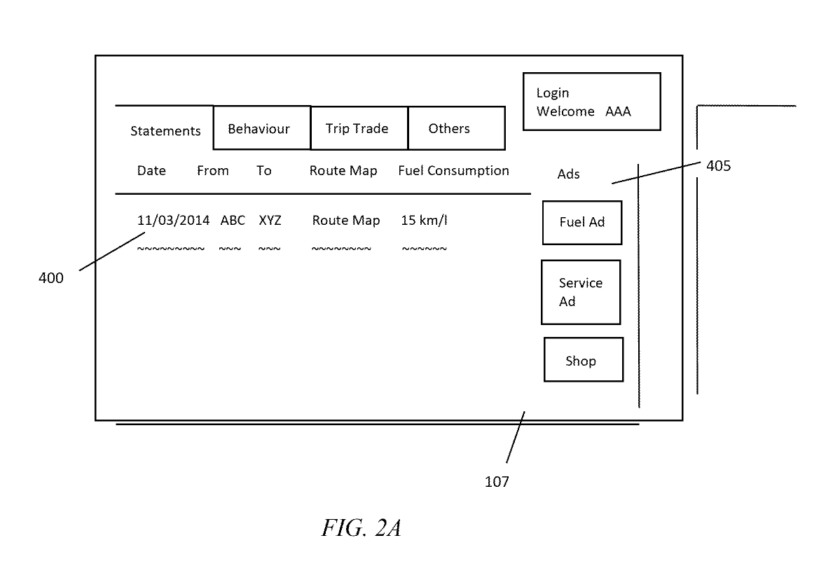

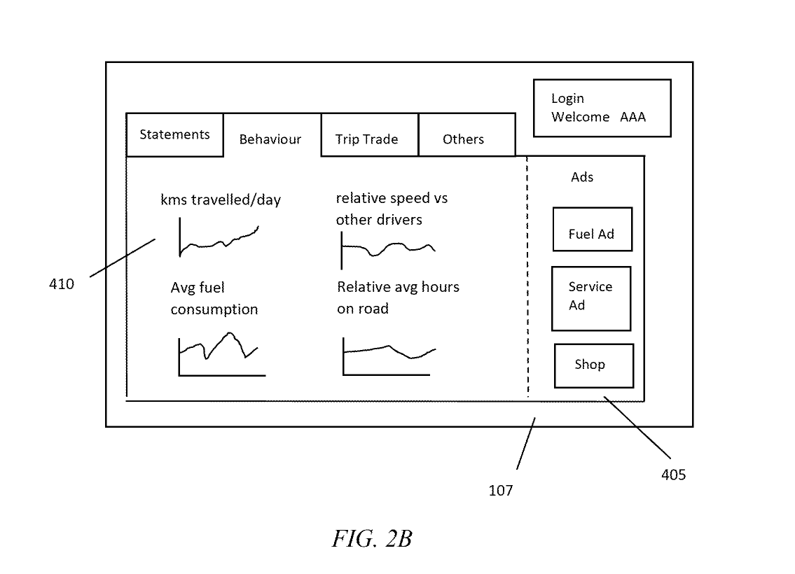

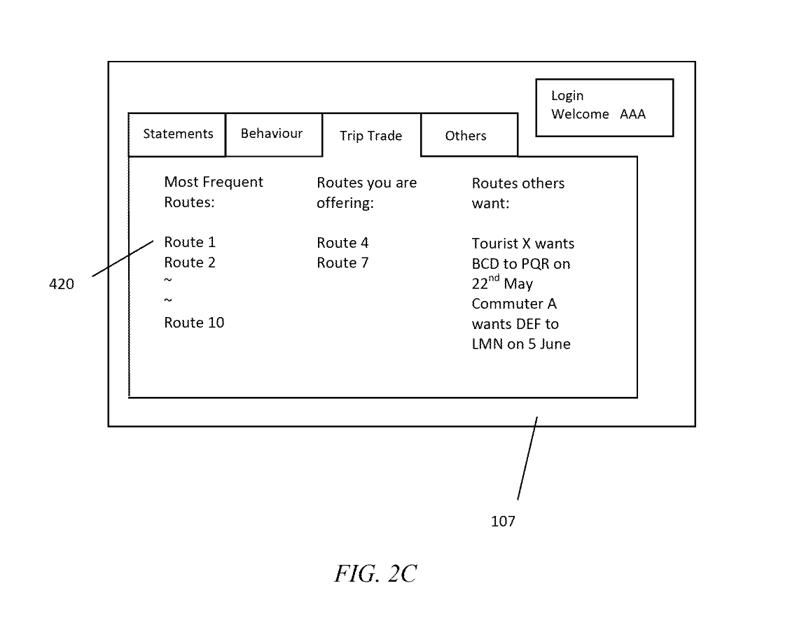

The memory device(s) 202 of the cloud server 200 may be configured to store the application and other software. The memory device(s) 202 may also be configured to store information such as the vehicle data obtained from the vehicle 100. The vehicle data received at the cloud server 200 is analysed by the processor 201 to generate processed vehicle data. The processed vehicle data may be provided to a user computing device located in a vehicle from which the vehicle data is collected. Alternatively, the processed vehicle data may be provided to a user computing device remote from the vehicle from which the vehicle data is collected. The processed vehicle data may be accessed via a portal of each of a plurality of user computing devices. It will thus be understood by those skilled in the art that vehicle data obtained from a plurality of vehicles may be used to generate processed vehicle data configured to be shared with multiple users. The processed vehicle data may comprise at least one of trip statements, trip behaviour, and trip trading options, and other applications which are described below. The processed vehicle data may be displayed on the display 107 in the vehicle, as illustrated in FIGS. 2A to 2C. A user interface integrated with the display 107 allows the entry of certain information about the user, and to allow selection of preferred options, as will be discussed below. The user interface functions to facilitate the capture of commands from the user such as an on-off commands or settings related to operation of the system. For example, the display 107 may comprise a touch screen user interface. The display 107 may be an off the shelf tablet device or a customized tablet-type device capable of being installed in the vehicle. All the functionality illustrated in FIGS. 2A to 2C may be accessible on the display 107. However, the display 107 may be configured to be operated in a limited functionality mode while the vehicle is being driven. That is, the driver of the vehicle may be prevented from interacting with the display 107 while driving the vehicle, thus preventing him or her from being distracted while driving. For example, the driver of the vehicle might not be able to trade trips on the display 107, but may be able to see whether there is traffic congestion ahead and recommendations for detours.

As mentioned above, the processed vehicle data may be configured to be accessed via a portal of each of a plurality of external computing devices 300. For example, the processed vehicle data may be configured to be displayed on the external computing devices 300 via an application or app configured to present the data in a manner similar to that displayed on the display 107 of the vehicle 100. The application may be a social media application configured to run on mobile devices such as smartphones, tablets, or the like. This allows other users in other situations outside of vehicles to view the processed vehicle data on their own device. For instance, a user B running the application on their mobile device may be able to see processed vehicle data generated from another user A who is driving a vehicle, wherein the users A and B are remote from each other.

FIGS. 2A to 2C are diagrams depicting an example of processed vehicle data displayed on a display device, according to embodiments of the present disclosure. For example, FIG. 2A is a diagram depicting an example of trip statements 400 displayed on the display 107 of the vehicle 100, according to an embodiment of the present disclosure. It will also be appreciated that the processed vehicle data may be configured to be displayed on a display of any of the external computing devices 300. Referring to FIG. 2A, the trip statements 400 may include a date and time stamp, origin, destination, route map and fuel consumption. The route map may be presented in a graphical format which if selected may be enlarged. Individual trip statements may be selected to display additional information on the trip. The additional information may comprise at least one of trip distance, start time, arrival time, and odometer reading.

Referring to FIG. 2A, the cloud server 200 may be configured to generate a number of advertisements 405 to be displayed to the user via the display 107. These advertisements 405 may be generated based on the vehicle data collected from one or more vehicles 100. For example, advertisements pertaining to businesses and services such as shops, restaurants, fuel stations, and the like may be displayed based on a route on which the user is currently travelling, or routes frequently used by the user. The businesses and services may be located on the route on which the user is currently travelling, or routes frequently used by the user. For example, an advertisement for a restaurant may be displayed in the advertisement section 405, wherein the restaurant is located along a route of one of the trip statements. Vehicle data collected from other users may also be used to generate and display advertisements relating to businesses on popular routes.

FIG. 2B is a diagram depicting examples of trip behaviour 410 displayed on the display 107 of the vehicle 100, according to an embodiment of the present disclosure. In the context of motor vehicle travel, the trip behaviour may comprise driving behaviour. Referring to FIG. 2B, the trip behaviour 410 may include metrics such as distance travelled per day, relative speed as compared to other drivers on the same route, average fuel consumption, and relative average hours spent on the road as compared to other drivers. The trip behaviour metrics may be displayed on the display 107 of the vehicle 100, and/or on a display of any of the external computing devices 300. The trip behaviour metrics may be displayed in graphical representation, as illustrated in FIG. 2B.

FIG. 2C is a diagram depicting an example of trip trading options 320 displayed on the display 107 of the vehicle 100, according to an embodiment of the present disclosure. The trip trading options may include a list of the user's most frequent routes, routes that the user is offering for trading, and routes other users are looking for trading. A user offering routes for trading may be an operator of the vehicle, such as a driver. Such a user is hereinafter referred to as a primary user. Users looking for routes for trading may be users without vehicles, hereinafter referred to as secondary users. Each of the most frequent routes, the routes that the user is offering for trading, and routes other users are looking for trading may be displayed in a list format, as illustrated in FIG. 2C. In the context of motor travel, the routes the user is offering for trading may comprise vehicle pooling options such as car pooling options. The trip trading options may be displayed in a column-type arrangement as depicted in FIG. 2C. The routes the primary user is offering for trading may be a subset of the primary user's most frequent routes. The most frequent routes may be displayed in a list format with each entry including the origin and destination. A new route created by a primary user may be added to the list. One or more of the most frequent routes may be configured to be selected by the primary user to be open for trading. That is, by selecting one or more of the most frequent routes, the primary user can inform other users of the system, including secondary users, that these routes are being offered for trading. The primary user may choose to associate a price with any of the routes being offered for trading. Alternatively, the primary user may choose to offer a route for free. The routes the primary user is offering for trading may also be displayed in a list format with each entry including the origin and destination, details of when the trip is being offered, which may include time and date information, and price information. The routes other users are looking for trading may be displayed in a list format with each entry including at least one of the origin and destination, details of when the trip is required, which may include time and date information, and price information. The routes the user is offering for trading may be configured to be checked to determine whether any other user of the system is willing to take up the trade being offered. If the primary user sees that a trip they are offering is matched by an offer from a secondary user, then contact information may be shared between the primary and secondary users to enable contact to be made between the primary and secondary users. As such, a marketplace for trading trips may be implemented in which primary users, such as drivers, and secondary users, such as non-driving or passenger users, may match trips being offered and requested. Secondary users can access the data using any web browser or mobile app.

The vehicle data may be analysed to generate other transport options as follows. For example, in a social media implementation in which there are multiple users, the cloud server 200 may process vehicle data from a plurality of users and push route recommendations to users. For example, if there is traffic congestion on a user's usual commuting route from ABC to XYZ based on vehicle data collected from a plurality of users, the cloud server 200 may recommend another less congested route. The cloud server 200 may also recommend other routes which may be more fuel efficient or having a shorter trip time.

In another application, the cloud server 200 may be configured to locate the vehicle based on vehicle data collected from the vehicle 100. The cloud server 200 may also be configured to use vehicle data to locate the vehicle 100 based on relative movement of the vehicle 100 compared to other vehicles on the same route. In the event of vehicle breakdown or emergency, the cloud server 200 may be configured in this scenario to send “Vehicle Breakdown Assistance” with an exact location, to a nearby breakdown assistance company.

In another application, if a driver of a vehicle 100 wants to make their vehicle location public, the cloud server 200 may be configured to circulate a link of their current route via email or social media to others. This enables others to determine the estimated arrival time of the driver. In another example, the processed vehicle data may be exported to third parties. The third parties may include insurance companies such as vehicle insurance companies. This enables, for example, car insurance companies to determine the driving habits of a driver from the processed vehicle data and offer better insurance rates if the driving habits compare favourably with those of other drivers.

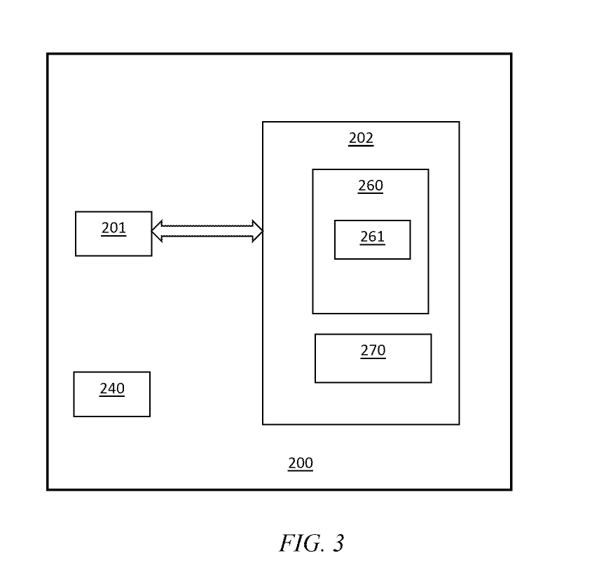

FIG. 3 is a block diagram illustrating a configuration of the cloud server 200, according to an embodiment of the present disclosure. The cloud server 200 includes various hardware and software components that function to perform the methods according to the present disclosure. Referring to FIG. 3, the cloud server 200 comprises a processor 201 in communication with a memory 202, and a communication interface 240. The processor 201 functions to execute software instructions that can be loaded and stored in the memory 202. The processor 201 may include a number of processors, a multi-processor core, or some other type of processor, depending on the particular implementation. The memory 202 may be accessible by the processor 201, thereby enabling the processor 201 to receive and execute instructions stored on the memory 202. The memory 202 may be, for example, a random access memory (RAM) or any other suitable volatile or non-volatile computer readable storage medium. In addition, the memory 202 may be fixed or removable and may contain one or more components or devices such as a hard drive, a flash memory, a rewritable optical disk, a rewritable magnetic tape, or some combination of the above.

One or more software modules 260 may be encoded in the memory 202. The one or more software modules 260 may comprise one or more software programs or applications 261 having computer program code or a set of instructions configured to be executed by the processor 201. Such computer program code or instructions for carrying out operations for aspects of the systems and methods disclosed herein may be written in any combination of one or more programming languages.

The one or more software modules 260 may include an application 261 configured to be executed by the processor 201. During execution of the application 261, the processor 201 configures the cloud server 200 to perform various operations relating to the facilitating and processing of steps according to embodiments of the present disclosure, as has been described above.

Other information and/or data relevant to the operation of the present systems and methods, such as a database 270, may also be stored on the memory 202. The database 270 may contain and/or maintain various data items and elements that are utilized throughout the various operations of the system described above. The information stored in the database 270 may include vehicle data such as the OBD data described above, and the vehicular analysis data and/or transport information generated from the vehicle data. It should be noted that although the database 270 is depicted as being configured locally to the cloud server 200, in certain implementations the database 270 and/or various other data elements stored therein may be located remotely. Such elements may be located on a remote device or server—not shown, and connected to the cloud server 200 through a network in a manner known to those skilled in the art, in order to be loaded into a processor and executed.

Further, the program code of the software modules 260 and one or more computer readable storage devices (such as the memory 202) form a computer program product that may be manufactured and/or distributed in accordance with the present disclosure, as is known to those of skill in the art.

The communication interface 240 is also operatively connected to the processor 201 and may be any interface that enables communication between the cloud server 200 and external devices, machines and/or elements including the external computing devices 300. The communication interface 240 is configured for transmitting and/or receiving data. For example, the communication interface 240 may include but is not limited to a Bluetooth, or cellular transceiver, a satellite communication transmitter/receiver, an optical port and/or any other such, interfaces for wirelessly connecting the cloud server 200 to the one or more external computing devices 300 and vehicles 100. Vehicle data received from the vehicle 100 via the vehicle interface module 106 may be communicated to the cloud server 200 via the communication interface 240. Similarly processed vehicle data generated from the vehicle data may be communicated to the vehicles 100 and the external computing devices 300 via the communication interface 240.

The operation of the cloud server 200 and the various elements and components described above will be understood by those skilled in the art with reference to the methods and systems according to the present disclosure. The methods and systems according to the present disclosure provide a user-friendly interactive means of sharing processed vehicle data between multiple users. Vehicle data obtained from a plurality of vehicles may be used to generate processed vehicle data configured to be shared with multiple users.

The present disclosure is not limited to the embodiment(s) described herein but can be amended or modified without departing from the scope of the present disclosure. Additionally, it will be appreciated that in embodiments of the present disclosure some of the above-described steps may be omitted and/or performed in an order other than that described.

What is claimed is:

1. A computer-implemented method for providing transport information to a plurality of user computing devices, the method being performed by a cloud computing system and comprising operating a processor associated with the cloud computing system to:
analyse vehicle data collated from one or more vehicles remote from the cloud computing system to generate processed vehicle data; and
configure the processed vehicle data to be accessed through a portal of each of the user computing devices.

2. The method of claim 1, further comprising providing the processed vehicle data to a user computing device located in a vehicle from which the vehicle data is collected.

3. The method of claim 1, further comprising providing the processed vehicle data to a plurality of user computing devices remote from the vehicle from which the vehicle data is collected.

4. The method of claim 1, wherein the vehicle data comprises at least one of vehicle metrics, on-board diagnostic (OBD) data and GPS data.

5. The method of claim 1, wherein the processed vehicle data comprises at least one of trip statements, trip behaviour metrics, and trip trading options.

6. The method of claim 5, wherein each of the trip statements comprises at least one of a date and time stamp, origin, destination, route map and fuel consumption.

7. The method of claim 6, wherein the route map is presented in a graphical format.

8. The method of claim 5, wherein individual trip statements are configured to be selected to display additional information on the trip.

9. The method of claim 8, wherein the additional information comprises at least one of trip distance, start time, arrival time, and odometer reading.

10. The method of claim 5, wherein the trip behaviour metrics comprises at least one of distance travelled per day, relative speed as compared to other travellers on the same route, average fuel consumption, and relative average hours spent on the route as compared to other travellers.

11. The method of claim 5, wherein the trip behaviour metrics are displayed in graphical representation.

12. The method of claim 5, wherein the trip trading options comprises a list of the user's most frequent routes, routes that the user is offering for trading, and routes other users are looking for trading.

13. The method of claim 12, wherein each of the most frequent routes, the routes that the user is offering for trading, and routes other users are looking for trading are displayed in a list format.

14. The method of claim 12, wherein the routes the user is offering for trading comprise vehicle pooling options.

15. The method of claim 14, further comprising allowing a user to associate a price with any of the routes being offered for trading.

16. The method of claim 12, wherein the routes the user is offering for trading are a subset of the user's most frequent routes.

17. The method of claim 12, further comprising allowing a new route to be created by a user.

18. The method of claim 12, wherein one or more of the most frequent routes is configured to be selected by a user to be open for trading.

19. The method of claim 18, further comprising informing other users that the selected routes are being offered for trading.

20. The method of claim 12, wherein each of the routes the user is offering for trading is displayed with at least one of the following:
origin and destination;
details of when the trip is being offered; and
price information.

21. The method of claim 12, wherein each of the routes other users are looking for trading is displayed with at least one of the following:
origin and destination;
details of when the trip is required; and
price information.

22. The method of claim 12, further comprising determining whether any of the routes the user is offering for trading is accepted by other users.

23. The method of claim 22, wherein if it is determined that a trip offered by a primary user is matched by an offer from a secondary user, allowing contact information to be shared between the primary and secondary users.

24. The method of claim 1, further comprising analysing vehicle data from a plurality of users and pushing route recommendations to users.

25. The method of claim 24, further comprising recommending a less congested route, a route which is more fuel efficient, or a route having a shorter trip time.

26. The method of claim 1, further comprising determining the location of a vehicle based on vehicle data received from the vehicle.

27. The method of claim 26, further comprising using vehicle data to locate the vehicle based on relative movement of the vehicle compared to other vehicles on the same route.

28. The method of claim 26, further comprising sending vehicle breakdown assistance with an exact location of the vehicle to a nearby breakdown assistance company in the event of vehicle breakdown or emergency.

29. The method of claim 1, further comprising allowing a user to make said user's vehicle location public.

30. The method of claim 29, further comprising circulating a link to the user's current route via email or a social media network.

31. The method of claim 1, further comprising exporting the processed vehicle data to third parties.

32. The method of claim 31, further comprising exporting the processed vehicle data to insurance companies.

33. The method of claim 1, comprising generating one or more advertisements to be displayed on the user computing device, the one or more advertisements associated with the vehicle data.

34. The method of claim 33, wherein the one or more advertisements are generated based on a route of the vehicle.

35. The method of claim 1, further comprising configuring the processed vehicle data for display on a display of each of the user computing devices.

36. The method of claim 35, further comprising providing the processed vehicle data for display on a user computing device located in a vehicle, wherein the display is configured such that a driver of the vehicle is prevented from interacting with the display while driving the vehicle.

37. The method of claim 1, further comprising receiving the vehicle data from one or more vehicles via a vehicle interface module.

38. A cloud computing system configured to deliver processed vehicle data to a plurality of user computing devices, the cloud computing system comprising:
a memory; and
a processor configured to:
analyse vehicle data collated from one or more vehicles remote from the cloud computing system to generate the processed vehicle data; and
configure the processed vehicle data to be accessed through a portal of each of the user computing devices.

39. A data-receiving computing device configured to receive processed vehicle data from a cloud computing system which analyses vehicle data collated from one or more vehicles remote from the cloud computing system to generate processed vehicle data, and configures the processed vehicle data to be accessed through a portal of each of a plurality of user computing devices including the data-receiving computing device, the data-receiving computing device comprising:
a processor; and
a display configured to display the processed vehicle data, the data-receiving computing device being remote from the cloud computing system.

40. The data-receiving computing device of claim 39, wherein said data-receiving computing device is located in a vehicle from which the vehicle data is collected.

41. The data-receiving computing device of claim 39, wherein said data-receiving computing device is remote from the vehicle from which the vehicle data is collected.

42. The data-receiving computing device of claim 39, wherein said data-receiving computing device is a mobile computing device.

43. The data-receiving computing device of claim 42, wherein said data-receiving computing device comprises a smartphone or tablet.

44. A non-transitory computer readable medium comprising computer executable instructions which when executed by a computer cause the computer to perform a method of for providing transport information to a plurality of user computing devices, the method being performed by a cloud computing system and comprising:
analysing vehicle data collated from one or more vehicles remote from the cloud computing system to generate processed vehicle data; and
configuring the processed vehicle data to be accessed through a portal of each of the user computing devices.
